(19) United States
(12) Patent Application Publication
(10) Pub. No.: US 2016/0343000 A1
(43) Pub. Date: Nov. 24, 2016

(54) Method and Service Center for Assisting a Customer to Navigate a Service

(71) Applicant: TELEFONAKTIEBOLAGET LM ERICSSON (PUBL), Stockholm (SE)

(72) Inventors: Dimitri Mazmanov, Solna (SE); Patrick Gullin, Torsås (SE); Thomas L Kelley, Whitehouse Station, NJ (US); Robert Törnkvist, Karlshamn (SE)

(21) Appl. No.: 15/112,735

(22) PCT Filed: Jan. 24, 2014
(86) PCT No.: PCT/SE2014/050086

§ 371 Date: Jul. 20, 2016

(51) Int. Cl. G06Q 30/00; G06Q 30/02

(52) U.S. Cl. CPC G06Q 30/016; G06Q 30/0201; G06Q 30/0281

(57) ABSTRACT

A method and service center (500, 600) for assisting a customer when said customer uses a communication device to navigate through a succession of choice options according to a default tree structure of option nodes. The service center obtains (202) customer information pertaining to the customer and identifies (204) from the customer information one or more customer-related keywords from a selection of predefined keywords. The service center then selects (206) a set of option nodes from the default tree structure based on a mapping of the one or more identified customer-related keywords to keywords assigned to the option nodes, and creates (208)a customized tree structure comprising the selected set of option nodes. The service center is then able to assist (210) the customer to navigate through a reduced succession of choice options in accordance with the customized tree structure, thus providing a more efficient and user-friendly experience to the customer.

### TECHNICAL FIELD

The present disclosure relates generally to a method and a service center for assisting a customer to navigate through a succession of choice options, e.g. when the customer places a call to a call center or the like for accessing a service.

### BACKGROUND

Networks for telecommunication of today are often configured with a service center or the like which can be contacted by a customer wherein the service center automatically assists the customer through a succession of choice options in order to assist or help the customer in a way that is relevant and adapted for the customer. Such a service center may also be employed for providing other types of services as well, such as banking, insurance and any retail shopping services, where the customer can be automatically guided by being asked to select a succession of choices until a final goal or objective is reached. Hence, the term “service” can be understood broadly in this disclosure in the sense that it can at least be navigated by the customer through multiple choice options.

The service may be call-based such that the customer calls the service center, e.g. a call center, and is assisted by an automatic voice to navigate through the various choice options needed to execute the service. In this case the customer uses a communication device capable of voice calling wherein the service center automatically offers the choice options by the automatic voice. Alternatively, the service may be web-based such that the customer is assisted over a web interface. In the latter case the customer uses a communication device capable of web browsing wherein the service center automatically offers the choice options in the form of buttons or links or similar.

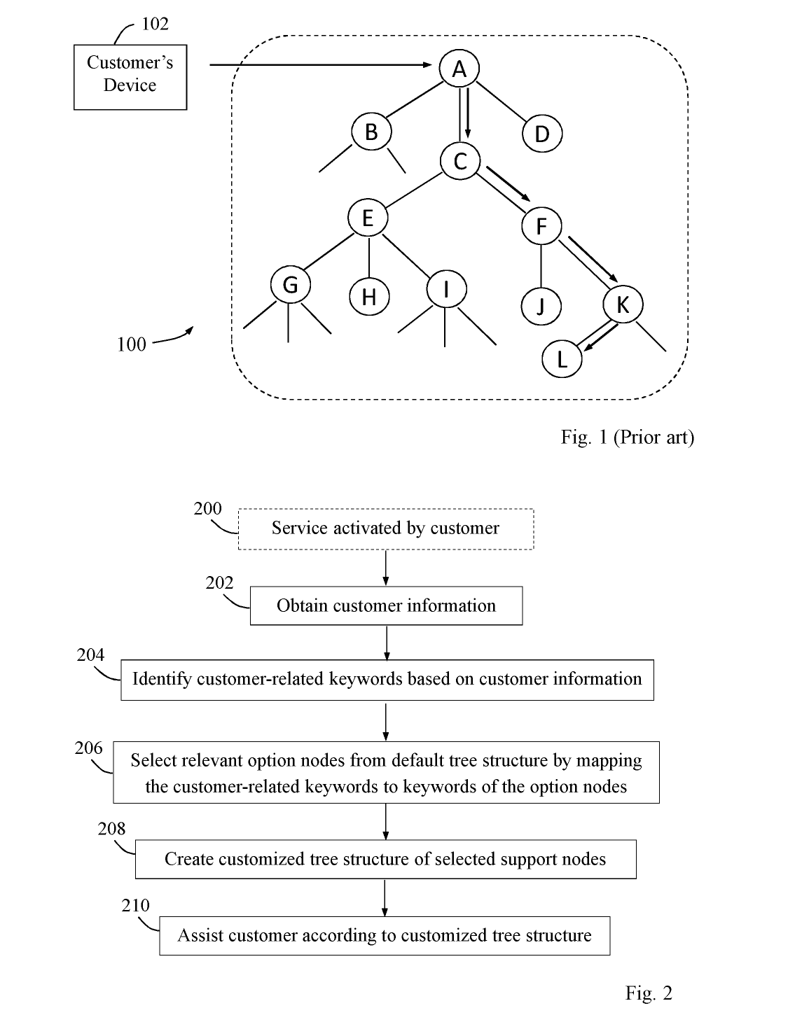

Throughout this disclosure, the term “customer” is used to represent any human user that may contact a service over a communication network, e.g. by placing a call to the service or by activating a web application of the service on a home page or the like. The communication network may be any type of network, such as a mobile or a fixed network, a public or a private network, to mention a few examples. The term “service center” further represents a functionality connected to the communication network which functionality is configured to assist a customer to navigate in a service by offering a succession of choice options which the user is able to select when progressing through the service. These choice options are often organized in the form of a hierarchical tree structure which may comprise multiple levels of option nodes, e.g. as illustrated in FIG. 1.

In FIG. 1, a service is configured to offer a succession of choice options according to a logic tree structure 100 of option nodes A, B, C, . . . representing various choices which are offered to the customer, e.g. by a voice prompt or a web-based interface. In this disclosure, the option nodes could alternatively be termed switches, selection nodes or points, and so forth. The customer thus needs to make a choice at each option node by selecting one of at least two offered options in order to move on towards execution of the service. The option nodes are thus not physical nodes but represent various options in the service in a logical and hierarchical manner, and the customer must navigate through the tree structure 100 in order to be ultimately guided to a human representative at a help desk or the like. First, the customer contacts the service using a communication device 102 and enters a top level option node A which offers three choice options B, C and D and the customer is automatically prompted to choose one of them. In a simple but illustrative example of a voice-based call service, the customer may be prompted to press 1 if the call refers to a complaint, to press 2 if the call relates to a subscription query, and to press 3 if the call relates to a billing issue, and so forth.

As illustrated in FIG. 1, a service may have several levels of such choice options which require the customer to make a choice or selection at each level, and in this example the customer chooses option C, option F, option K and finally option L, as indicated by the arrows. After choosing option L, the customer may for example be routed to a service staff who can discuss with the customer in more detail when serving the customer in a suitable manner.

This kind of tree structure of option nodes may be quite extensive depending on the nature and complexity of the service, such that the customer is required to make several choices at different option nodes before being served in a desired manner. It is however a problem that customers often find this navigation procedure rather tiresome and time-consuming, which is a nuisance particularly if the service is accessed at several occasions, and may therefore even choose to exit the service before reaching the final desired service option, e.g. a fitting representative. For example, the customer may have to listen to several more or less irrelevant options being offered at each level, before a relevant option is presented that can be chosen to progress to the next option level.

### SUMMARY

It is an object of embodiments described herein to address at least some of the problems and issues outlined above. It is possible to achieve this object and others by using a method and a service center as defined in the attached independent claims.

According to one aspect, a method is performed by a service center for assisting a customer when said customer uses a communication device to navigate through a succession of choice options according to a default tree structure of option nodes. In this method the service center obtains customer information pertaining to the customer, and identifies, based on the obtained customer information, one or more customer-related keywords from a selection of predefined keywords. The service center then selects a set of option nodes from the default tree structure based on a mapping of the one or more identified customer-related keywords to keywords assigned to the option nodes, and creates a customized tree structure comprising the selected set of option nodes such that there are less option nodes in the customized tree structure than in the default tree structure. The service center further assists the customer to navigate through a reduced succession of choice options in accordance with the customized tree structure.

Advantages of the procedure described herein include that any option nodes that are deemed irrelevant, predictable or not applicable for this particular customer can be omitted from the customized tree structure, so that the customer is not required to spend time to go through such option nodes and select options therein. Thereby, the navigation procedure will be made smoother and more user-friendly for the customer who will be less likely to become bored and even give up before reaching the final goal or objective. Thus, an enhanced customer experience may be provided and the automatic assistance of customers is made more efficient in terms of time and complexity.

According to another aspect, a service center is arranged to assist a customer when said customer uses a communication device to navigate through a succession of choice options according to a default tree structure of option nodes. The service center is configured to obtain customer information pertaining to the customer, and to identify, based on the obtained customer information, one or more customer-related keywords from a selection of predefined keywords. The service center is further configured to select a set of option nodes from the default tree structure based on a mapping of the one or more identified customer-related keywords to keywords assigned to the option nodes, and to create a customized tree structure comprising the selected set of option nodes such that there are less option nodes in the customized tree structure than in the default tree structure. The service center is also configured to assist the customer to navigate through a reduced succession of choice options in accordance with the customized tree structure.

The above method and service center may be configured and implemented according to different optional embodiments to accomplish further features and benefits, to be described below.

Brief Description of Drawings

The solution will now be described in more detail by means of exemplary embodiments and with reference to the accompanying drawings, in which:

FIG. 1 is a schematic diagram illustrating navigation through a service with several choice options organized in a tree structure, according to the prior art.

FIG. 2 is a flow chart illustrating a procedure performed by a service center, according to some possible embodiments.

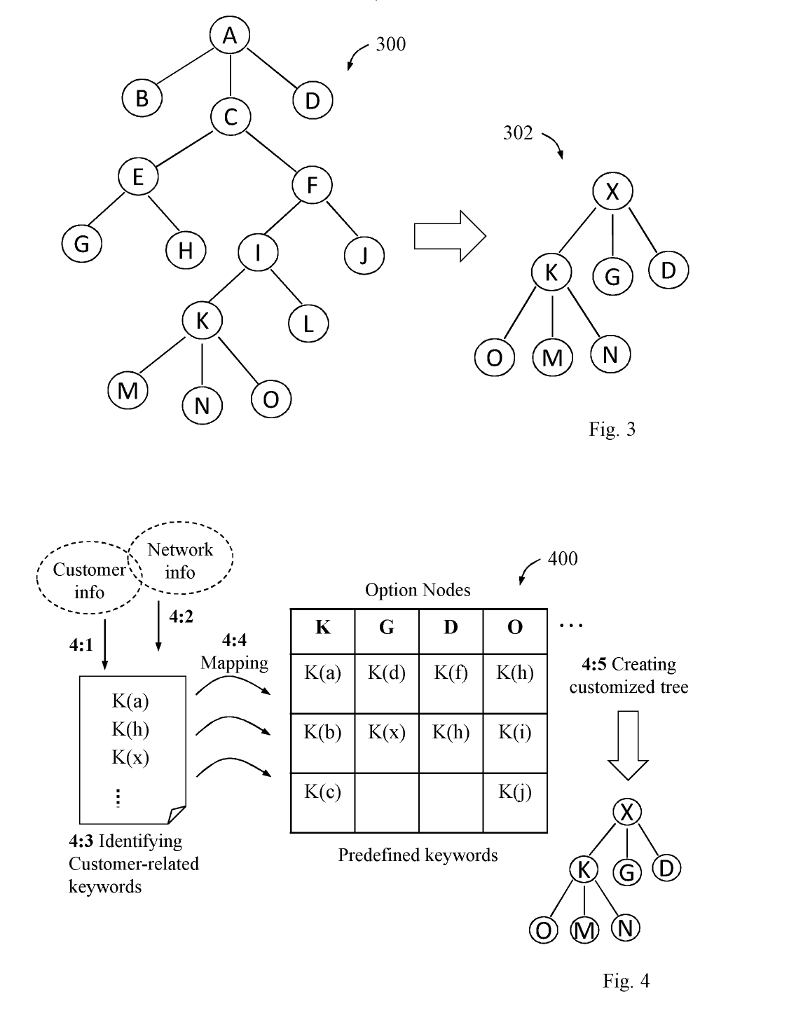

FIG. 3 is a is a schematic node diagram illustrating an example of how a customized tree structure may be created from a default tree structure, according to further possible embodiments.

FIG. 4 is a is a schematic workflow diagram illustrating an example of how a service center may operate to create a customized tree structure based on customer information and network information, according to further possible embodiments.

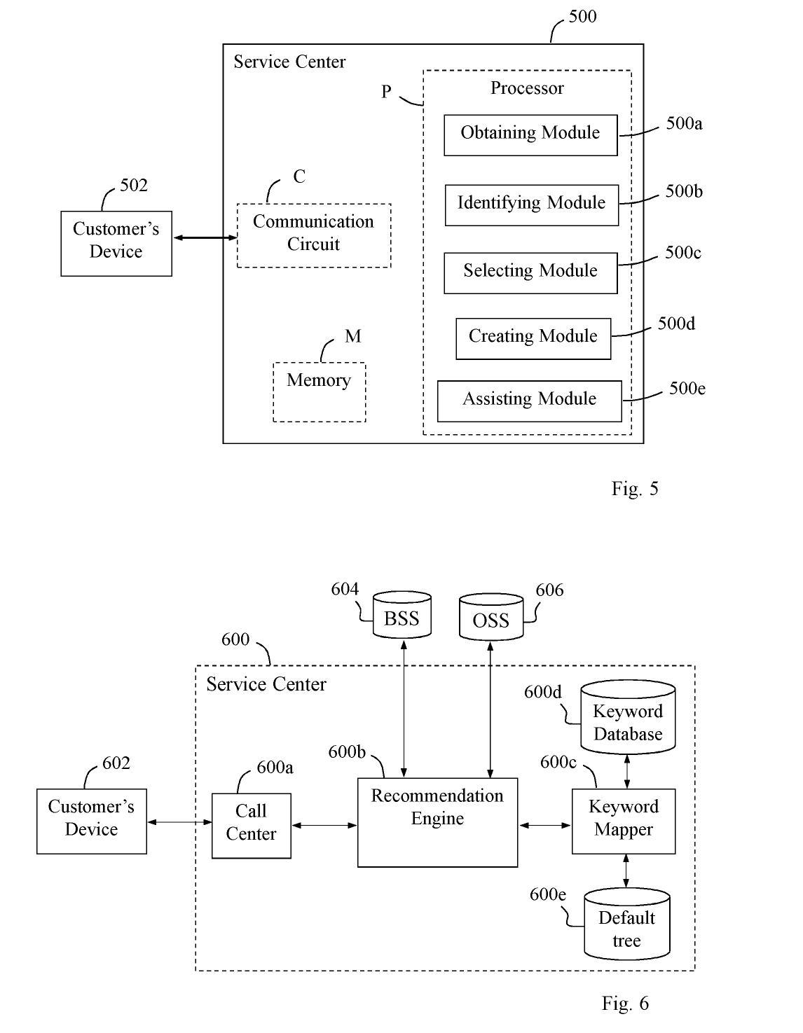

FIG. 5 is a block diagram illustrating a service center in more detail, according to further possible embodiments.

FIG. 6 is another block diagram illustrating how a service center may be implemented in practice, according to further possible embodiments.

### DETAILED DESCRIPTION

In this solution, it has been realized that the above-described procedure of navigating through a service would be less tiresome for the customer if the tree structure of option nodes could be simplified and reduced to comprise a smaller number of options which are more or less relevant to the customer, instead of including many irrelevant options that the customer is forced to listen to. Briefly described, this is accomplished by creating a customized tree structure in which any option nodes that are deemed irrelevant or predictable for this particular customer have been removed, to provide a reduced succession of choice options though which the customer can be assisted. Thereby, the service will be made more user-friendly and the customer will be less likely to find the navigation procedure tiresome and not give up before reaching the final goal or objective.

An example of how this may be done will now be described with reference to the flow chart in FIG. 2 which illustrates actions performed by a service center which is arranged to assist a customer when he/she uses a communication device to navigate through a succession of choice options according to a default tree structure of option nodes. It is assumed that the default tree has originally been configured to be applicable for any customer in a conventional manner, e.g. basically as illustrated in FIG. 1. It is further assumed that a range, or selection, of descriptive keywords have been predefined for this procedure and that some of these keywords have been assigned to the option nodes in the default tree such that one or more such keywords is/are associated with each option node. Thus in a possible embodiment, one or more predefined keywords have been assigned to each option node in the default tree structure. For example, the keyword “private” may be assigned to an option node that is only relevant or useful for private issues.

The communication device used by the customer may be any device, e.g. a mobile or fixed telephone, a tablet or a Personal Computer (PC), capable of contacting a service over a communication network. The service could be of any type that is accessed by an automatic assistance procedure and may relate to a call subscription, banking, insurance, retail shopping or health care, to mention as few common but non-limiting examples.

A first action 200 illustrates schematically that the service center detects that the customer has activated or accessed a service offered by the service center, e.g. by automatic voice or by a web interface. In some possible embodiments, the service center may perform the actions of FIG. 2 when the customer places a call to a service or activates a web application of the service.

In a next action 202, the service center obtains customer information pertaining to the customer, which may be retrieved from a customer database or the like, e.g. based on a telephone number, network address, log-in code, or other identification of the customer which is received or obtained during the access or activation procedure of action 200. The service center may thus have access to such customer information being maintained in a register, record, inventory, or the like. In a possible embodiment, the service center may retrieve the customer information from a Business Support System, BSS, serving the customer. For example, the BSS may belong to a communication network serving the customer and his/her communication device. The customer information will be used for creating the customized tree structure with a reduced number of option nodes as compared to the default tree structure, as follows.

In this procedure it is assumed that the customer information is useful for predicting how the customer would choose at one or more of the option nodes of the default tree structure in order to omit such option nodes in the customized tree structure. Some non-limiting examples of customer information that may be obtained in action 202 are presented below:
A) Services previously used by the customer, which may imply that the customer has uses the same service or similar services before and is likely to navigate and choose in the same manner in the presently accessed service.
B) Services that the customer subscribes to, which information may be used to limit the number of choice options in the customized tree structure e.g. by excluding options related to services that the customer does not subscribes to.
C) Subscription settings valid for the customer, which information may be used to limit the number of choice options in the customized tree structure e.g. by excluding options related to subscription settings that are not valid for the customer.
D) Demographic and personal data of the customer such as e.g. age, gender, home address, profession, interests, etc.
E) Services that are frequently used by others in an area where the customer is present, which may imply that the customer is likely to use these services as well when being in the area.
F) Services that have been problematic for the customer, which may imply that the customer is likely to have contacted the service center to discuss or otherwise deal with the problematic services.
G) Characteristics of the customer's communication device, which information may be used to limit the number of choice options in the customized tree structure e.g. by excluding options related to communication devices not having those characteristics.
H) Service quality metrics indicating the customer's experience of previous service usage, which may imply preferences and/or requirements of the customer.
I) Any problems experienced by the customer's communication device, which may imply that the customer is likely to have contacted the service center to discuss or otherwise deal with the device problems.

In a further action 204, the service center identifies, based on the obtained customer information, one or more customer-related keywords from the above-mentioned selection of predefined keywords. In other words, the service center selects only those keywords in the above-mentioned selection of predefined keywords that somehow match the customer as reflected by the obtained customer information, and hence the selected keywords are deemed to be valid for this particular customer.

Another action 206 illustrates that the service center selects a set of option nodes from the default tree structure based on a mapping of the one or more identified customer-related keywords to the keywords that have been assigned to the option nodes. This mapping operation will be described in more detail later below with reference to FIG. 4.

In another possible embodiment, the service center may select the option nodes in the default tree structure further based on a current state of a used communication network in an area where the customer is present, which communication network is thus used by the customer and his/her communication device when accessing the service center. In that case the service center may retrieve the state of the communication network from an Operations Support System, OSS of the communication network, according to a further possible embodiment. For example, the current state of the communication network may indicate that there is a problem with communications in the area due to some malfunction or network failure, which information may imply that certain option node(s) in the tree is/are unsuitable or irrelevant for the customer.

In a further action 208, the service center creates the aforementioned customized tree structure for the customer such that the customized tree structure comprises the selected set of option nodes, but not the other option nodes that were not selected from the default tree structure, such that there are less option nodes in the customized tree structure than in the default tree structure. For example, a node that asks for the customer's profession can be omitted altogether when that is already known through the customer information obtained in action 202.

The option nodes in the selected set of option nodes may further be weighted in terms of assumed importance or relevance to the customer, such that the customized tree structure can be organized in accordance with the weights to further enable efficient and smooth navigation in the customized tree for the customer. Thus in another possible embodiment, the service center may determine weights for the one or more customer-related keywords and then creates the customized tree structure such that option nodes which map keywords of relatively higher weight are prioritized in the customized tree structure over option nodes which map keywords of relatively lower weight. In other words, the service center may organize the option nodes in an efficient order such that presumably more important or relevant choice options, according to their weight, are offered earlier than less important or relevant choice options. Thereby, particularly in the case of a voice-based interface, the customer is able to select an offered option that is potentially attractive and proceed before the remaining and less attractive options have been offered. The service center may, in yet another possible embodiment, determine the above weights based on a history of service usage by the customer which may have been accumulated in a usage database or the like that the service center can access.

In a final shown action 210, the service center assists, i.e. guides, the customer to navigate through a reduced succession of choice options in accordance with the customized tree structure. Thereby, the procedure of navigating through the choice options can be made more efficient and user-friendly than in conventional tree-like or hierarchical navigation services. Moreover, the succession of choice options in the customized tree structure may have been organized in a way so as to be even more efficient and less time-consuming to navigate for the customer by offering potentially more attractive options before offering less attractive options at one or more levels in the tree structure, as explained above.

Naturally, since the selection of option nodes to include in the default tree structure is more or less based on various assumptions, there may be instances when the created customized tree structure is not optimal or helpful in view of the actual needs and intentions of the customer which may of course change over time. Therefore, it should be possible for the customer to abandon the customized tree structure if it turns out to be less serviceable and use the default tree structure instead to be able to choose from all options configured therein. In a possible embodiment, the service center may therefore revert to assist the customer to navigate through the choice options in accordance with the default tree structure when the customer has selected an exit option. For example, a voice or other dialog function may announce: “if you wish to exit the customized mode of choice options, press x”, or similar.

FIG. 3 illustrates a simplified example of how a default tree structure 300 may be modified when creating a customized tree structure 302 where option nodes A-C, E, F, H-J and L have been omitted, e.g. because they relate to options that are not valid for the customer as deduced from the customer information in the manner described above. X represents a new point of entrance to the choice procedure in the customized tree structure 302 offering alternatives K, G, D, presumably being more relevant to the customer than A offering alternatives B, C, D in the default tree structure 300. Furthermore, the order of the remaining option nodes K, G, D, O, M and N have been reorganized according to the above-described weighting feature.

FIG. 4 illustrates schematically how different keywords pertaining to the customer can be mapped to different option nodes of the default tree structure 302 of FIG. 3 depending on keywords assigned to these option nodes, in a procedure performed by the above-described service center. In this example, customer information is obtained in an action 4:1 and network information is also obtained in another action 4:2. In a further action 4:3, a set of customer-related keywords K(a), K(h), K(x) . . . are identified from a selection of predefined keywords based on the customer information, basically as described for action 204 above.

Then, a mapping operation is performed in an action 4:4, where the identified customer-related keywords K(a), K(h), K(x) . . . are compared with the different keywords that have been assigned to different option nodes in the default tree structure. Finally, in an action 4:5, the customized tree structure is created from those option nodes K, G, D, O, . . . in the default tree structure that have one or more of the customer-related keywords K(a), K(h), K(x) . . . identified in action 4:3, according to the shown mapping table 400. In this example, option node K has the customer-related keyword K(a), option node G has the customer-related keyword K(x), option node D has the customer-related keyword K(h), and option node O has also keyword K(h), and so forth.

A detailed but non-limiting example of how a service center may be structured with some possible functional entities such as modules, circuits or units, to bring about the above-described functionality of the service center, is illustrated by the block diagram in FIG. 5. In this figure, the service center 500 is arranged to assist a customer when said customer uses a communication device 502 to navigate through a succession of choice options according to a default tree structure of option nodes. The service center 500 may be configured to operate according to any of the examples and embodiments of employing the solution as described above and as follows. In particular, the service center 500 may be arranged or configured to perform at least the actions of the flow chart in FIG. 2 and also according to FIG. 4 in the manner described above. In order to accomplish this, the service center 500 may be implemented with a communication circuit C, a memory M and an operable processor P comprising various functional modules as described below.

More specifically, the service center 500 is configured to obtain customer information pertaining to the customer, which may be performed by an obtaining module 500a, e.g. as described for action 202 above. The service center 500 is also configured to identify, based on the obtained customer information, one or more customer-related keywords from a selection of predefined keywords. This identifying operation may be performed by an identifying module 500b, e.g. as described for action 204 above.

The service center 500 is also configured to select a set of option nodes from the default tree structure based on a mapping of the one or more identified customer-related keywords to keywords assigned to the option nodes. This selecting operation may be performed by an selecting module 500c, e.g. as described for action 206 above. The service center 500 is also configured to create a customized tree structure comprising the selected set of option nodes such that there are less option nodes in the customized tree structure than in the default tree structure. This creating operation may be performed by an creating module 500d, e.g. as described for action 208 above. Further, the service center 500 is configured to assist the customer to navigate through a reduced succession of choice options in accordance with the customized tree structure. This assisting operation may be performed by an assisting module 500e, e.g. as described for action 210 above.

The above service center 500 and its functional modules and units may be configured or arranged to operate according to various optional embodiments such as those described above in connection with FIGS. 2 and 4. It should be noted that FIG. 5 illustrates some possible functional modules in the service center 500 and the skilled person is able to implement these functional modules in practice using suitable software and hardware. Thus, the solution is generally not limited to the shown structures of the service center 500, and the functional modules 500a-e may be configured to operate according to any of the features described in this disclosure, where appropriate.

The embodiments and features described herein may be implemented in a computer program comprising computer readable code which, when run on a service center, causes the service center to perform the above actions e.g. as described for FIGS. 2 and 4. Further, the above-described embodiments may be implemented in a computer program product comprising a computer readable medium on which the above computer program is stored. The computer program product may be a compact disc or other carrier suitable for holding the computer program. Some examples of how the computer program and computer program product can be realized in practice are outlined below.

The functional modules 500a-e described above for FIG. 5 may be implemented in the service center 500 by means of program modules of a respective computer program comprising code means which, when run by the processor “P” causes the service center 500 to perform the above-described actions and procedures. The processor P may comprise a single Central Processing Unit (CPU), or could comprise two or more processing units. For example, the processor P may include a general purpose microprocessor, an instruction set processor and/or related chips sets and/or a special purpose microprocessor such as an Application Specific Integrated Circuit (ASIC). The processor P may also comprise a storage for caching purposes.

Each computer program may be carried by a computer program product in the service center 500 in the form of the shown memory “M” having a computer readable medium and being connected to the processor P. The computer program product or memory M thus comprises a computer readable medium on which the computer program is stored e.g. in the form of computer program modules. For example, the memory M may be a flash memory, a Random-Access Memory (RAM), a Read-Only Memory (ROM) or an Electrically Erasable Programmable ROM (EEPROM), and the program modules m could in alternative embodiments be distributed on different computer program products in the form of memories within the service center 500.

An illustrative but non-limiting example of how the above-described solution may be implemented in practice will now be described with reference to the block diagram in FIG. 6 depicting a service center 600 which is configured basically to operate according to any of the features and embodiments described above. It is again assumed that a default tree structure has been configured for a service which is generally useful by any customer for navigating the service, and that a range of descriptive keywords have been predefined, and that at least some of these keywords have been assigned to various option nodes in the default tree structure.

In this example, the service center 600 comprises a call center 600a which is operable as a voice-based communication interface towards a communication device 602 used by a customer for accessing the service in the service center 600. In the call center 600a an automatic voice function is implemented to assist the customer through a succession of choice options when navigating the service, in the manner described above.

The service center 600 is also implemented with a recommendation engine 600b which is operable to create a customized tree structure in the above-described manner. The recommendation engine 600b is configured to obtain customer information from a BSS 604, e.g. as in action 202 above, and also to obtain the state of the communication network used by the customer's device 602 from an OSS 606, which also have been described above. The recommendation engine 600b is further operable to obtain a mapping from a keyword mapper 600c between one or more identified customer-related keywords and keywords that have been assigned to the option nodes. The keyword mapper 600c may be operable to identify customer-related keywords from a selection of predefined keywords being stored in a keyword database 600d, e.g. as in action 204 above, and to select option nodes from the default tree structure, based on the above mapping, e.g. as in action 206 above. The default tree structure may be maintained in a default tree database 600e in the service center 600.

The recommendation engine 600b is further operable to create a customized tree structure with the selected set of option nodes, e.g. as in action 208 above. Finally, the call center 600a is operable to assist the customer to navigate through a reduced succession of choice options in accordance with the customized tree structure, e.g. as in action 210 above. While the solution has been described with reference to specific exemplifying embodiments, the description is generally only intended to illustrate the inventive concept and should not be taken as limiting the scope of the solution. For example, the terms “service center”, “tree structure”, “option node” and “keyword” have been used throughout this disclosure, although any other corresponding entities, functions, and/or parameters could also be used having the features and characteristics described here. The solution is defined by the appended claims.

1-22. (canceled)

23. A method, performed by a service center, for assisting a customer when said customer uses a communication device to navigate through a succession of choice options according to a default tree structure of option nodes, the method comprising:
obtaining customer information pertaining to the customer;
identifying, based on the customer information, one or more customer-related keywords from a selection of predefined keywords;
selecting a set of option nodes from the default tree structure based on a mapping of the one or more identified customer-related keywords to keywords assigned to the option nodes;
creating a customized tree structure comprising the selected set of option nodes such that there are less option nodes in the customized tree structure than in the default tree structure; and
assisting the customer to navigate through a reduced succession of choice options in accordance with the customized tree structure.

24. The method according to claim 23, wherein the customer information pertains to at least one of:
services previously used by the customer,
services that the customer subscribes to,
subscription settings valid for the customer,
demographic data of the customer,
services that are frequently used by others in an area where the customer is present,
services that have been problematic for the customer,
characteristics of the communication device,
service quality metrics indicating the customer's experience of previous service usage, and
problems experienced by the communication device.

25. The method according to claim 23, wherein the service center retrieves the customer information from a Business Support System (BSS) serving the customer.

26. The method according to claim 23, wherein the service center determines weights for the one or more customer-related keywords and creates the customized tree structure such that option nodes that map to keywords of relatively higher weight are prioritized in the customized tree structure over option nodes that map to keywords of relatively lower weight.

27. The method according to claim 26, wherein the service center determines the weights based on a history of service usage by the customer.

28. The method according to claim 23, wherein the service center selects the option nodes in the default tree structure further based on a current state of a used communication network in an area where the customer is present.

29. The method according to claim 28, wherein the service center retrieves the current state of the used communication network from an Operations Support System (OSS) of the used communication network.

30. The method according to claim 23, wherein one or more predefined keywords have been assigned to each option node in the default tree structure.

31. The method according to claim 23, wherein the service center performs the method responsive to the customer placing a call to a service or activating a web application of the service.

32. The method according to claim 23, wherein the service center reverts to assisting the customer to navigate through the choice options in accordance with the default tree structure responsive to the customer selecting an exit option.

33. A service center arranged to assist a customer when said customer uses a communication device to navigate through a succession of choice options according to a default tree structure of option nodes, the service center comprising:
communication circuitry configured to communicate with the communication device; and
processing circuitry operatively connected to the communication circuitry and configured to:
obtain customer information pertaining to the customer;
identify, based on the customer information, one or more customer-related keywords from a selection of predefined keywords;
select a set of option nodes from the default tree structure based on a mapping of the one or more identified customer-related keywords to keywords assigned to the option nodes;
create a customized tree structure comprising the selected set of option nodes such that there are less option nodes in the customized tree structure than in the default tree structure; and
assist the customer to navigate through a reduced succession of choice options in accordance with the customized tree structure.

34. The service center according to claim 33, wherein the customer information pertains to at least one of:
services previously used by the customer,
services that the customer subscribes to,
subscription settings valid for the customer,
demographic data of the customer,
services that are frequently used by others in an area where the customer is present,
services that have been problematic for the customer,
characteristics of the communication device,
service quality metrics indicating the customer's experience of previous service usage, and
problems experienced by the communication device.

35. The service center according to claim 33, wherein the processing circuitry is configured to retrieve the customer information from a Business Support System (BSS) serving the customer.

36. The service center according to claim 33, wherein the processing circuitry is configured to determine weights for the one or more customer-related keywords and to create the customized tree structure such that option nodes that map keywords of relatively higher weight are prioritized in the customized tree structure over option nodes that map keywords of relatively lower weight.

37. The service center according to claim 36, wherein the processing circuitry is configured to determine the weights based on a history of service usage by the customer.

38. The service center according to claim 33, wherein the processing circuitry is configured to select the option nodes in the default tree structure further based on a current state of a used communication network in an area where the customer is present.

39. The service center according to claim 38, wherein the processing circuitry is configured to retrieve the state of the communication network from an Operations Support System (OSS) of the communication network.

40. The service center according to claim 33, wherein one or more predefined keywords have been assigned to each option node in the default tree structure.

41. The service center according to claim 33, wherein the processing circuitry is configured to perform the operations when the customer places a call to a service or activates a web application of the service.

42. The service center according to claim 33, wherein the processing circuitry is configured to revert to assist the customer to navigate through the choice options in accordance with the default tree structure when the customer has selected an exit option.

43. A non-transitory computer readable storage medium storing a computer program for assisting a customer when said customer uses a communication device to navigate through a succession of choice options according to a default tree structure of option nodes, the computer program comprising computer readable code that, when run on at least one processor of a service center, causes the service center to:
obtain customer information pertaining to the customer;
identify, based on the customer information, one or more customer-related keywords from a selection of predefined keywords;
select a set of option nodes from the default tree structure based on a mapping of the one or more identified customer-related keywords to keywords assigned to the option nodes;
create a customized tree structure comprising the selected set of option nodes such that there are less option nodes in the customized tree structure than in the default tree structure; and
assist the customer to navigate through a reduced succession of choice options in accordance with the customized tree structure.
